(19) United States
(12) Patent Application Publication
(10) Pub. No.: US 2014/0074542 A1
(43) Pub. Date: Mar. 13, 2014

(54) Systems and Methods for Forecasting HVAC Operation Cost

(71) Applicant: Trane International Inc., Piscataway, NJ (US)

(72) Inventor: John Raymond Edens, Kilgore, TX (US)

(21) Appl. No.: 14/025,559

(22) Filed: Sep. 12, 2013

Related U.S. Application Data
(60) Provisional application No. 61/700,450, filed on Sep. 13, 2012.

(51) Int. Cl. G06Q 10/06

(52) U.S. Cl. CPC G06Q 10/06315
USPC 705/7.25

(57) ABSTRACT

A method of projecting a cost of operating a heating, ventilation, and/or air conditioning (HVAC) system includes providing weather forecast data to a system controller of the HVAC system, providing energy cost data to the system controller, providing an interface to the system controller, and generating a first projected cost of operating the HVAC system as a function of the weather forecast data and the energy cost data.

### CROSS-REFERENCE TO RELATED APPLICATIONS

The present application claims priority to U.S. Provisional Patent Application No. 61/700,450, filed on Sep. 13, 2012 by John Raymond Edens, entitled “Systems and Methods for Forecasting HVAC Operation Cost,” which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Heating, ventilation, and/or air conditioning (HVAC) systems with programmable system controllers may be used to control the indoor temperature of buildings. The programmable systems may adjust a user selected temperature based on a schedule. HVAC systems may consume a large amount of energy, relative to other building systems, and changes in weather may affect the amount of energy consumed.

### SUMMARY

In some embodiments of the disclosure, a method of projecting a cost of operating a heating, ventilation, and/or air conditioning (HVAC) system is disclosed as comprising providing weather forecast data to a system controller of the HVAC system, providing energy cost data to the system controller, providing an interface to the system controller, and generating a first projected cost of operating the HVAC system as a function of the weather forecast data and the energy cost data.

In other embodiments of the disclosure, a heating, ventilation, and/or air conditioning (HVAC) system comprising a system controller configured to receive weather forecast data and energy cost data and further configured to generate a projected cost of operating the HVAC system as a function of the weather forecast data and the energy cost data is disclosed.

In yet other embodiments of the disclosure, a system controller for a heating, ventilation, and/or air conditioning (HVAC) system is disclosed. The system controller is disclosed as being configured to receive weather forecast data and energy cost data and further being configured to generate a projected cost of operating the HVAC system as a function of the weather forecast data and the energy cost data.

These and other features will be more clearly understood from the following detailed description taken in conjunction with the accompanying drawings and claims.

### BRIEF DESCRIPTION OF THE DRAWINGS

FIG. 1 is a schematic diagram of an HVAC system according to an embodiment of the disclosure;

FIG. 2 is a simplified schematic diagram of the air circulation paths of the HVAC system of FIG. 1;

FIG. 3 is a flowchart of a method of forecasting an operation cost of an HVAC system according to an embodiment of the disclosure;

FIG. 4 is a flowchart of another method of forecasting an operation cost of an HVAC system according to an embodiment of the disclosure;

FIG. 5 is an interface for receiving HVAC system setup settings according to an embodiment of the disclosure;

FIG. 6 is an energy cost predictor interface according to an embodiment of the disclosure;

FIG. 7 is an energy cost predictor interface according to another embodiment of the disclosure; and

FIG. 8 is a simplified representation of a general-purpose processor (e.g. electronic controller or computer) system suitable for implementing the embodiments of the disclosure.

### DETAILED DESCRIPTION

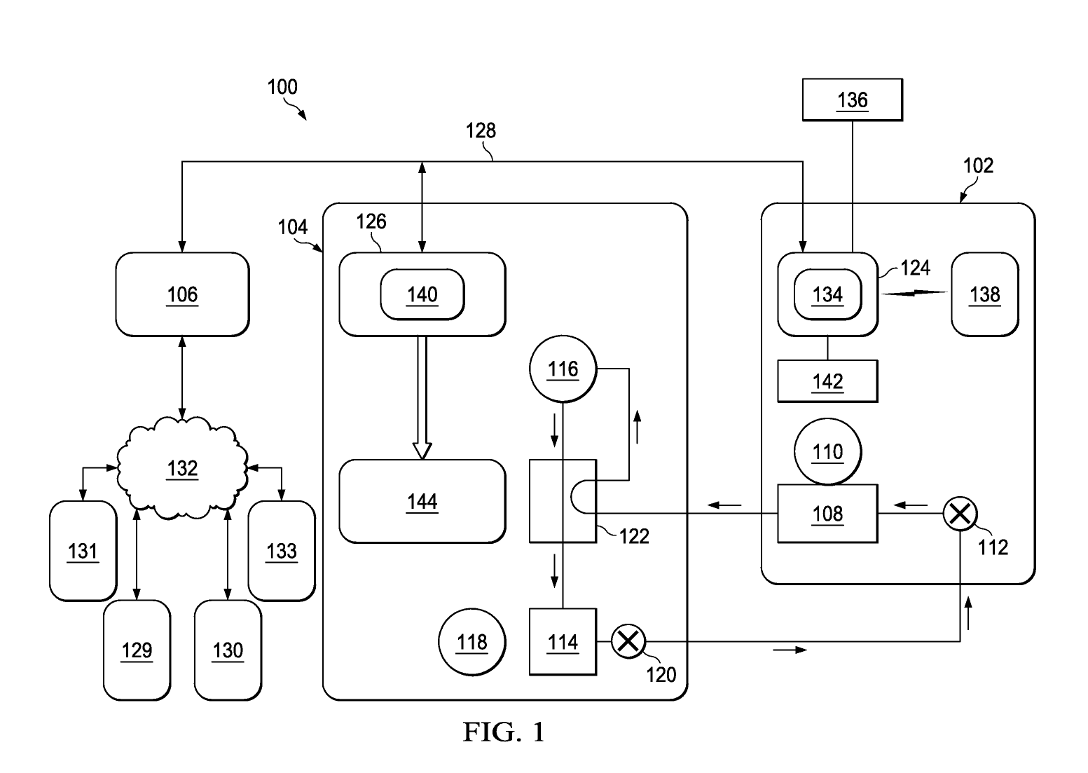

Referring now to FIG. 1, a schematic diagram of an HVAC system 100 according to an embodiment of this disclosure is shown. HVAC system 100 comprises an indoor unit 102, an outdoor unit 104, and a system controller 106. In some embodiments, the system controller 106 may operate to control operation of the indoor unit 102 and/or the outdoor unit 104. As shown, the HVAC system 100 is a so-called heat pump system that may be selectively operated to implement one or more substantially closed thermodynamic refrigeration cycles to provide a cooling functionality and/or a heating functionality.

Indoor unit 102 comprises an indoor heat exchanger 108, an indoor fan 110, and an indoor metering device 112. Indoor heat exchanger 108 is a plate fin heat exchanger configured to allow heat exchange between refrigerant carried within internal tubing of the indoor heat exchanger 108 and fluids that contact the indoor heat exchanger 108 but that are kept segregated from the refrigerant. In other embodiments, indoor heat exchanger 108 may comprise a spine fin heat exchanger, a microchannel heat exchanger, or any other suitable type of heat exchanger.

The indoor fan 110 is a centrifugal blower comprising a blower housing, a blower impeller at least partially disposed within the blower housing, and a blower motor configured to selectively rotate the blower impeller. In other embodiments, the indoor fan 110 may comprise a mixed-flow fan and/or any other suitable type of fan. The indoor fan 110 is configured as a modulating and/or variable speed fan capable of being operated at many speeds over one or more ranges of speeds. In other embodiments, the indoor fan 110 may be configured as a multiple speed fan capable of being operated at a plurality of operating speeds by selectively electrically powering different ones of multiple electromagnetic windings of a motor of the indoor fan 110. In yet other embodiments, the indoor fan 110 may be a single speed fan.

The indoor metering device 112 is an electronically controlled motor driven electronic expansion valve (EEV). In alternative embodiments, the indoor metering device 112 may comprise a thermostatic expansion valve, a capillary tube assembly, and/or any other suitable metering device. The indoor metering device 112 may comprise and/or be associated with a refrigerant check valve and/or refrigerant bypass for use when a direction of refrigerant flow through the indoor metering device 112 is such that the indoor metering device 112 is not intended to meter or otherwise substantially restrict flow of the refrigerant through the indoor metering device 112.

Outdoor unit 104 comprises an outdoor heat exchanger 114, a compressor 116, an outdoor fan 118, an outdoor metering device 120, and a reversing valve 122. Outdoor heat exchanger 114 is a spine fin heat exchanger configured to allow heat exchange between refrigerant carried within internal passages of the outdoor heat exchanger 114 and fluids that contact the outdoor heat exchanger 114 but that are kept segregated from the refrigerant. In other embodiments, outdoor heat exchanger 114 may comprise a plate fin heat exchanger, a microchannel heat exchanger, or any other suitable type of heat exchanger.

The compressor 116 is a multiple speed scroll type compressor configured to selectively pump refrigerant at a plurality of mass flow rates. In alternative embodiments, the compressor 116 may comprise a modulating compressor capable of operation over one or more speed ranges, the compressor 116 may comprise a reciprocating type compressor, the compressor 116 may be a single speed compressor, and/or the compressor 116 may comprise any other suitable refrigerant compressor and/or refrigerant pump.

The outdoor fan 118 is an axial fan comprising a fan blade assembly and fan motor configured to selectively rotate the fan blade assembly. In other embodiments, the outdoor fan 118 may comprise a mixed-flow fan, a centrifugal blower, and/or any other suitable type of fan and/or blower. The outdoor fan 118 is configured as a modulating and/or variable speed fan capable of being operated at many speeds over one or more ranges of speeds. In other embodiments, the outdoor fan 118 may be configured as a multiple speed fan capable of being operated at a plurality of operating speeds by selectively electrically powering different ones of multiple electromagnetic windings of a motor of the outdoor fan 118. In yet other embodiments, the outdoor fan 118 may be a single speed fan.

The outdoor metering device 120 is a thermostatic expansion valve. In alternative embodiments, the outdoor metering device 120 may comprise an electronically controlled motor driven EEV, a capillary tube assembly, and/or any other suitable metering device. The outdoor metering device 120 may comprise and/or be associated with a refrigerant check valve and/or refrigerant bypass for use when a direction of refrigerant flow through the outdoor metering device 120 is such that the outdoor metering device 120 is not intended to meter or otherwise substantially restrict flow of the refrigerant through the outdoor metering device 120.

The reversing valve 122 is a so-called four-way reversing valve. The reversing valve 122 may be selectively controlled to alter a flow path of refrigerant in the HVAC system 100 as described in greater detail below. The reversing valve 122 may comprise an electrical solenoid or other device configured to selectively move a component of the reversing valve 122 between operational positions.

The system controller 106 may comprise a touchscreen interface for displaying information and for receiving user inputs. The system controller 106 may display information related to the operation of the HVAC system 100 and may receive user inputs related to operation of the HVAC system 100. However, the system controller 106 may further be operable to display information and receive user inputs tangentially and/or unrelated to operation of the HVAC system 100. In some embodiments, the system controller 106 may comprise a temperature sensor and may further be configured to control heating and/or cooling of zones associated with the HVAC system 100. In some embodiments, the system controller 106 may be configured as a thermostat for controlling supply of conditioned air to zones associated with the HVAC system.

In some embodiments, the system controller 106 may selectively communicate with an indoor controller 124 of the indoor unit 102, with an outdoor controller 126 of the outdoor unit 104, and/or with other components of the HVAC system 100. In some embodiments, the system controller 106 may be configured for selective bidirectional communication over a communication bus 128. In some embodiments, portions of the communication bus 128 may comprise a three-wire connection suitable for communicating messages between the system controller 106 and one or more of the HVAC system 100 components configured for interfacing with the communication bus 128. Still further, the system controller 106 may be configured to selectively communicate with HVAC system 100 components and/or other device 130 via a communication network 132. In some embodiments, the communication network 132 may comprise a telephone network and the other device 130 may comprise a telephone. In some embodiments, the communication network 132 may comprise the Internet and the other device 130 may comprise a so-called smartphone and/or other Internet enabled mobile telecommunication device.

The indoor controller 124 may be carried by the indoor unit 102 and may be configured to receive information inputs, transmit information outputs, and otherwise communicate with the system controller 106, the outdoor controller 126, and/or any other device via the communication bus 128 and/or any other suitable medium of communication. In some embodiments, the indoor controller 124 may be configured to communicate with an indoor personality module 134, receive information related to a speed of the indoor fan 110, transmit a control output to an electric heat relay, transmit information regarding an indoor fan 110 volumetric flow-rate, communicate with and/or otherwise affect control over an air cleaner 136, and communicate with an indoor EEV controller 138. In some embodiments, the indoor controller 124 may be configured to communicate with an indoor fan controller 142 and/or otherwise affect control over operation of the indoor fan 110. In some embodiments, the indoor personality module 134 may comprise information related to the identification and/or operation of the indoor unit 102 and/or a position of the outdoor metering device 120.

In some embodiments, the indoor EEV controller 138 may be configured to receive information regarding temperatures and pressures of the refrigerant in the indoor unit 102. More specifically, the indoor EEV controller 138 may be configured to receive information regarding temperatures and pressures of refrigerant entering, exiting, and/or within the indoor heat exchanger 108. Further, the indoor EEV controller 138 may be configured to communicate with the indoor metering device 112 and/or otherwise affect control over the indoor metering device 112.

The outdoor controller 126 may be carried by the outdoor unit 104 and may be configured to receive information inputs, transmit information outputs, and otherwise communicate with the system controller 106, the indoor controller 124, and/or any other device via the communication bus 128 and/or any other suitable medium of communication. In some embodiments, the outdoor controller 126 may be configured to communicate with an outdoor personality module 140 that may comprise information related to the identification and/or operation of the outdoor unit 104. In some embodiments, the outdoor controller 126 may be configured to receive information related to an ambient temperature associated with the outdoor unit 104, information related to a temperature of the outdoor heat exchanger 114, and/or information related to refrigerant temperatures and/or pressures of refrigerant entering, exiting, and/or within the outdoor heat exchanger 114 and/or the compressor 116. In some embodiments, the outdoor controller 126 may be configured to transmit information related to monitoring, communicating with, and/or otherwise affecting control over the outdoor fan 118, a compressor sump heater, a solenoid of the reversing valve 122, a relay associated with adjusting and/or monitoring a refrigerant charge of the HVAC system 100, a position of the indoor metering device 112, and/or a position of the outdoor metering device 120. The outdoor controller 126 may further be configured to communicate with a compressor drive controller 144 that is configured to electrically power and/or control the compressor 116.

The HVAC system 100 is shown configured for operating in a so-called cooling mode in which heat is absorbed by refrigerant at the indoor heat exchanger 108 and heat is rejected from the refrigerant at the outdoor heat exchanger 114. In some embodiments, the compressor 116 may be operated to compress refrigerant and pump the relatively high temperature and high pressure compressed refrigerant from the compressor 116 to the outdoor heat exchanger 114 through the reversing valve 122 and to the outdoor heat exchanger 114. As the refrigerant is passed through the outdoor heat exchanger 114, the outdoor fan 118 may be operated to move air into contact with the outdoor heat exchanger 114, thereby transferring heat from the refrigerant to the air surrounding the outdoor heat exchanger 114. The refrigerant may primarily comprise liquid phase refrigerant and the refrigerant may be pumped from the outdoor heat exchanger 114 to the indoor metering device 112 through and/or around the outdoor metering device 120 which does not substantially impede flow of the refrigerant in the cooling mode. The indoor metering device 112 may meter passage of the refrigerant through the indoor metering device 112 so that the refrigerant downstream of the indoor metering device 112 is at a lower pressure than the refrigerant upstream of the indoor metering device 112. The pressure differential across the indoor metering device 112 allows the refrigerant downstream of the indoor metering device 112 to expand and/or at least partially convert to gaseous phase. The gaseous phase refrigerant may enter the indoor heat exchanger 108. As the refrigerant is passed through the indoor heat exchanger 108, the indoor fan 110 may be operated to move air into contact with the indoor heat exchanger 108, thereby transferring heat to the refrigerant from the air surrounding the indoor heat exchanger 108. The refrigerant may thereafter reenter the compressor 116 after passing through the reversing valve 122.

To operate the HVAC system 100 in the so-called heating mode, the reversing valve 122 may be controlled to alter the flow path of the refrigerant, the indoor metering device 112 may be disabled and/or bypassed, and the outdoor metering device 120 may be enabled. In the heating mode, refrigerant may flow from the compressor 116 to the indoor heat exchanger 108 through the reversing valve 122, the refrigerant may be substantially unaffected by the indoor metering device 112, the refrigerant may experience a pressure differential across the outdoor metering device 120, the refrigerant may pass through the outdoor heat exchanger 114, and the refrigerant may reenter the compressor 116 after passing through the reversing valve 122. Most generally, operation of the HVAC system 100 in the heating mode reverses the roles of the indoor heat exchanger 108 and the outdoor heat exchanger 114 as compared to their operation in the cooling mode.

Still further, the system controller 106 may be configured to selectively communicate with other systems via the communication network 132. In some embodiments, the system controller 106 may communicate with weather forecast data providers (WFDPs) 133, such as the National Weather Service and The Weather Channel, which may provide weather forecast data via the network 132. In some embodiments, the system controller 106 may communicate with a customized data providers (CDPs) 131, such as home automation service provider authorized by the manufacturer of system controller 106, which may provide weather forecast data specifically formatted for use by system controllers 106. In this case, the CDP 131 may be designed or authorized by the system controller 106 manufacturer to store data such as a location of an HVAC system 100 installation, HVAC system 100 model number, HVAC system 100 serial number, and/or other HVAC system 100 data for system controllers 106. Such data may further comprise details on the installation of the HVAC system 100, including features of the buildings, energy suppliers, and physical sites. Such data may be provided by any of the HVAC system 100 owner, the HVAC system 100 installer, the HVAC system 100 distributor, the HVAC system 100 manufacturer, and/or any other entity associated with the manufacture, distribution, purchase, and/or installation of HVAC system 100.

The CDP 131 may also collect, process, store, and/or redistribute information supplied from system controllers 106. Such information may comprise HVAC system 100 service data, HVAC system 100 repair data, HVAC system 100 malfunction alerts, HVAC system 100 operational characteristics, measurements of weather conditions local to the HVAC system 100, energy cost data, HVAC system 100 run times, and/or any other information available to the system controller 106.

CDP 131 may also be configured to gather data from the WFDPs 133 and communicate with other devices 130, such as, telephones, smart phones, and/or personal computers. CDP 131 may also, for example, collect energy cost data from another web site and provide the energy cost data to system controller 106. CDP 131 may be controlled and operated by any entity authorized to communicate with system controller 106. Authorization for access to system controller 106 may take the form of a password, encryption, and/or any other suitable authentication method. Optionally, authorization may be disabled using system controller 106.

CDP 131 may be configured to allow for the setup of account login information to remotely configure system controller 106. For example, the CDP 131 may provide the user using an opportunity to configure system controller 106 with a large general purpose computer screen and greater number of interface features than may be available on a user interface of system controller 106, in some cases, allowing the interface of system controller 106 to be smaller and/or eliminated entirely.

System controller 106 may also be configured to communicate with other Internet sites 129. Such other data providers (ODPs) 129 may provide current time and/or energy cost data of the energy suppliers for HVAC system 100. For example, system controller 106 may communicate with a local energy provider to retrieve current energy cost data.

The weather forecast data provided by WFDPs 133 may comprise one or more of predicted: temperatures, solar conditions, sunrise times, sunset times, dew point temperatures, wind chill factors, average wind speeds, wind speed ranges, maximum wind speeds, wind directions, relative humidity, snow, rain, sleet, hail, barometric pressure, heat index, air quality, air pollution, air particulates, ozone, pollen counts, fog, cloud cover, and/or any other available atmospheric and/or meteorological variable that may affect energy consumption of the HVAC system 100. The weather forecast data may be retrieved for intervals that span ten days, a week, a day, 4 hours, 2 hours, one hour, a quarter hour, and/or another available interval into the future relative to the time of retrieval.

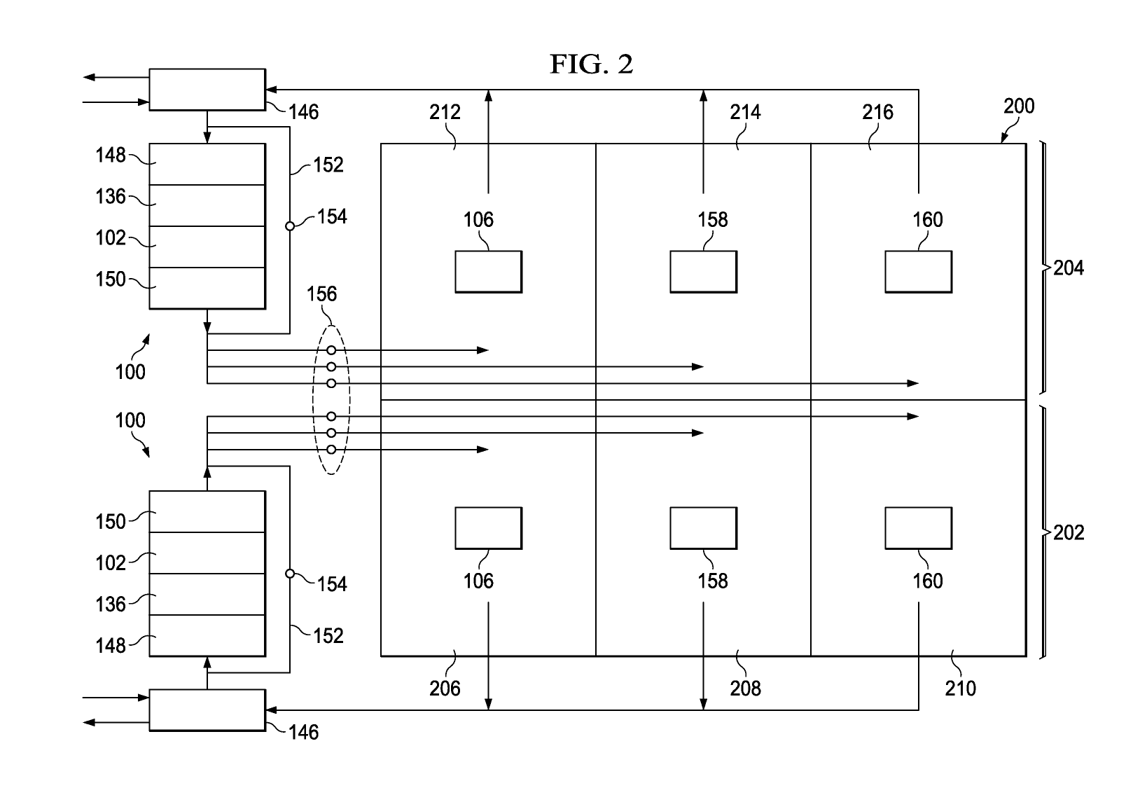

Referring now to FIG. 2, a simplified schematic diagram of the air circulation paths for a structure 200 conditioned by two HVAC systems 100 is shown. In this embodiment, the structure 200 is conceptualized as comprising a lower floor 202 and an upper floor 204. The lower floor 202 comprises zones 206, 208, and 210 while the upper floor 204 comprises zones 212, 214, and 216. The HVAC system 100 associated with the lower floor 202 is configured to circulate and/or condition air of lower zones 206, 208, and 210 while the HVAC system 100 associated with the upper floor 204 is configured to circulate and/or condition air of upper zones 212, 214, and 216.

In addition to the components of HVAC system 100 described above, in this embodiment, each HVAC system 100 further comprises a ventilator 146, a prefilter 148, a humidifier 150, and a bypass duct 152. The ventilator 146 may be operated to selectively exhaust circulating air to the environment and/or introduce environmental air into the circulating air. The prefilter 148 may generally comprise a filter media selected to catch and/or retain relatively large particulate matter prior to air exiting the prefilter 148 and entering the air cleaner 136. The humidifier 150 may be operated to adjust a humidity of the circulating air. The bypass duct 152 may be utilized to regulate air pressures within the ducts that form the circulating air flow paths. In some embodiments, air flow through the bypass duct 152 may be regulated by a bypass damper 154 while air flow delivered to the zones 206, 208, 210, 212, 214, and 216 may be regulated by zone dampers 156.

Still further, each HVAC system 100 may further comprise a zone thermostat 158 and a zone sensor 160. In some embodiments, a zone thermostat 158 may communicate with the system controller 106 and may allow a user to control a temperature, humidity, and/or other environmental setting for the zone in which the zone thermostat 158 is located. Further, the zone thermostat 158 may communicate with the system controller 106 to provide temperature, humidity, and/or other environmental feedback regarding the zone in which the zone thermostat 158 is located. In some embodiments, a zone sensor 160 may communicate with the system controller 106 to provide temperature, humidity, and/or other environmental feedback regarding the zone in which the zone sensor 160 is located. compare

While HVAC systems 100 are shown as a so-called split system comprising an indoor unit 102 located separately from the outdoor unit 104, alternative embodiments of an HVAC system 100 may comprise a so-called package system in which one or more of the components of the indoor unit 102 and one or more of the components of the outdoor unit 104 are carried together in a common housing or package. The HVAC system 100 is shown as a so-called ducted system where the indoor unit 102 is located remote from the conditioned zones, thereby requiring air ducts to route the circulating air. However, in alternative embodiments, an HVAC system 100 may be configured as a non-ducted system in which the indoor unit 102 and/or multiple indoor units 102 associated with an outdoor unit 104 is located substantially in the space and/or zone to be conditioned by the respective indoor units 102, thereby not requiring air ducts to route the air conditioned by the indoor units 102.

Still referring to FIG. 2, the system controllers 106 may be configured for bidirectional communication with each other and may further be configured so that a user may, using any of the system controllers 106, monitor and/or control any of the HVAC system 100 components regardless of which zones the components may be associated. Further, each system controller 106, each zone thermostat 158, and each zone sensor 160 may comprise a humidity sensor. As such, it will be appreciated that structure 200 is equipped with a plurality of humidity sensors in a plurality of different locations. In some embodiments, a user may effectively select which of the plurality of humidity sensors is used to control operation of one or more of the HVAC systems 100.

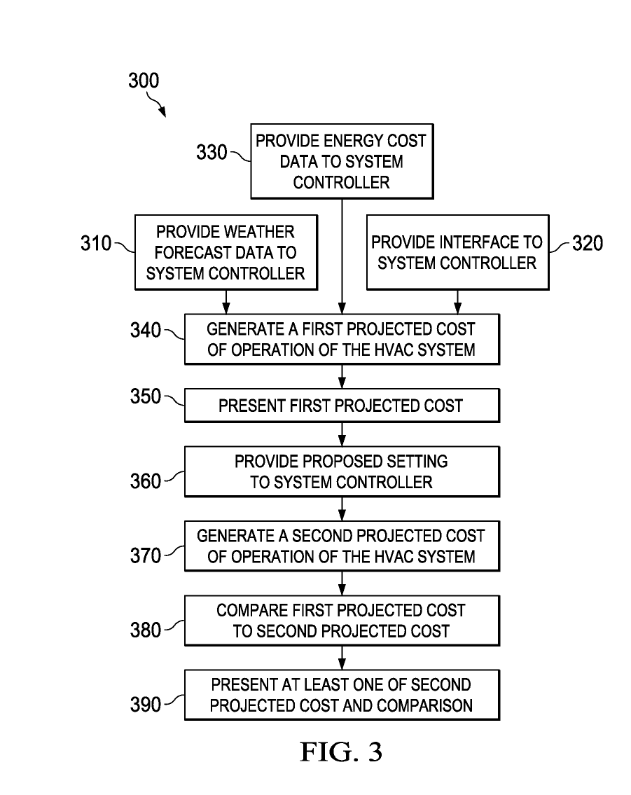

Referring now to FIG. 3, a flowchart of a method 300 of predicting a future energy consumption cost of an HVAC system 100 is illustrated. The method 300 may begin at any of blocks 310, 320, and 330 and, in some embodiments, the actions of blocks 310, 320, and 330 may be required to be performed prior to method 300 progressing to block 340.

At block 310, weather forecast data may be provided to a system controller 106. At block 330, energy cost data may be provided to system controller 106. Weather forecast data may be retrieved from WFDPs 133 and/or CDPs 131 in response to related and ongoing operations of the system controller 106 to perform functions which may require the retrieval of weather forecast data. Weather forecast data may be retrieved from WFDPs 133 and/or CDPs 131 in response to an input from a user of the HVAC system 100, a scheduled event, and/or a data push from at least one of a WFDP 133 and a CDP 131. A data push may be defined as a transfer of weather forecast data to the system controller 106 that is not initiated by the system controller 106.

At block 320, the system controller 106 may provide an interface to configure the system controller 106. Alternatively, other devices 130 or a remote access terminal of CDP 131 may provide an interface to configure the system controller 106. The system controller 106 configuration may comprise any relevant setting for an HVAC system 100 such as heating temperature set point, cooling temperature set point, indoor temperature range, indoor relative humidity setpoint, indoor relative humidity range, fresh air exchange rate, circulating fan rates, air filtration power, and/or any other suitable settings. The interface may be, for example, a graphical interface, a touch screen interface, a menu-driven interface, and/or a combination of different types of interfaces.

At block 330, the method 300 may comprise providing energy cost data to the system controller 106. The system controller 106 may automatically poll a local energy provider to retrieve energy cost data. For example, the HVAC system 100 may poll the local energy provider for current electricity costs, and/or energy cost schedules related to peak and off-peak intervals, predicted energy cost data, and/or variable energy cost structures. Alternatively, the system controller 106 may obtain energy cost data from CDP 131, other devices 130, and/or or as a user input through a touch screen interface of system controller 106.

At block 340, after receiving weather forecast data, energy cost data, and presenting the user with an interface to a system controller 106 setting for HVAC system 100, the system controller 106 may estimate a first projected cost of operating the HVAC system 100. The first projected cost may be based on HVAC system 100 settings, the energy cost data, and the weather forecast data. Estimation of the first projected cost may be accomplished by modeling the performance of the HVAC system 100 as a function of HVAC system 100 settings, factors related to the environment in which HVAC system 100 is installed, and the weather forecast data. The modeled performance may provide a first consumption forecast, as an estimation of future energy inputs into the HVAC system 100 over a specified time. The energy cost data may be applied to the first consumption forecast to arrive at the first projected cost.

The first consumption forecast may be calculated through the use of a thermodynamic model of the HVAC system 100 and the environment in which the HVAC system 100 is installed. For example, the HVAC system 100 may receive additional various inputs to model the thermodynamic characteristics of the structure 200. The operation of the structure 200 may include opening and closing doors and windows, internal heat inputs due to energy consumption not associated with the HVAC system 100 (e.g. appliances), shading, lighting, and other quantifiable conditions which relate to energy sources and drains to and from the internal structure 200 environment. These inputs may be supplied, for example, by an HVAC system user, an HVAC system 100 installer, an HVAC system 100 manufacturer, ODPs 129, other devices 130, CDPs 131, WFDPs 133, and/or combination thereof.

A thermodynamic model of an environment in which HVAC system 100 is installed may be a simple model comprising just a few parameters about structure 200, such as, square footage of controlled climate living space, number of floors, and construction type (brick, log, conventional frame, etc.). A thermodynamic model may be more refined, comprising a three dimensional model of the roof (including surface reflectivity, insulation, pitch, orientation), exterior walls, heat conduction through exterior walls, wall construction, wall surface reflectivity, wall orientation, window placement, window type (including, for example, window properties such as reflectivity, number of glazings, type of glazings, type of gas insulation, age, seals, etc.), doors (materials, type, area, seals, etc.), foundation, effective air leakage rates, air exchange due to normal use of doors and windows, surrounding landscape (mountains, hills, valleys, nearby artificial structures, water, trees, bushes), and/or any other structure 200 data. Further, the thermodynamic model may use a simple or a refined representation of weather. Weather calculations may comprise utilizing a model of sky radiation, cloud cover, solar and shading calculations, radiation reflected from exterior surfaces of structure 200, air and heat balances, ground heat transfer processes, infrared radiation heat exchanges, convective heat exchanges, moisture transfers, wind speed and direction, and/or any other suitable weather related factor.

A thermodynamic model may also utilize real-world information obtained from mapping services such as the United States Geological Service (USGS) or Internet-based services which provide satellite and aerial image data. Images of the property, together with the orientation of the structure 200, surrounding features and topography may be obtained to augment or replace digital photographs provided by the user. Alternatively, construction plans of structure 200 may be utilized to model structure 200.

Once a thermodynamic model of the structure 200 and related surroundings is constructed, the physics of the interactions between the building and the related environment may be modeled at varying levels of detail. In some embodiments, temperatures, solar inputs, wind cooling, and air leakages may be reduced to just a few simple numbers representing averages. The averages may be used in calculations with historic and weather forecast data to calculate the first consumption forecast. In some embodiments, the physics of the structure 200 may be very specific. The thermodynamic model may comprise the location, orientation, thermal resistance value, and reflectivity of each surface of the structure 200 in square inch or square foot units. Solar inputs may be modeled by ray-tracing algorithms. Wind and convective cooling may be modeled by vector fields. Instead of applying heat balance equations to whole walls or windows, each square inch on the surface of the structure 200 may be calculated.

A thermodynamic model which may generate the first consumption forecast may include hourly weather data (or include any available weather data on finer or coarser time-scales), and may rely on historic weather data and energy usage data saved by the system controller 106 on a previous occasion. The calculations may involve interpolating the previous weather data to fit the current weather forecast data. For example if saved weather data includes no contiguous set of days matching the projected forecast (including approximate time of year, which may be useful important for modeling solar inputs), the calculations may assemble non-contiguous periods most closely matching the periods in the forecast. The model may also assemble close data from a plurality of periods, and interpolate between them. For example, if the weather forecast data indicates a cloudy day in March with a high temperature of 50 degrees F. and low temperature of 40 degrees F., there may be no relevant saved days with that general temperature profile. The modeling may be accomplished by interpolating between two saved cloudy March days, one with a high temperature of 55 degrees F. and low temperature of 45 degrees F., and the other with a high temperature of 45 degrees F. and a low temperature of 35 degrees F. The interpolation may use proportional estimations, or curve fitting as necessary. The interpolation may occur on timescales of quarter hours, hours, days, or any relevant period for which weather data is saved.

In some embodiments, a model may account for semi-interior features of the house, including any attic structure, unheated garage areas, and ventilation of these areas. Attics, garages, three-season rooms and other non-climate controlled areas may provide a buffer region between the climate controlled portions of the home and the non-climate controlled exterior. These areas may be accounted for based on their thermal masses. The areas may comprise HVAC system 100 equipment, duct work, or other household utilities that create a heat load on the system.

The first projected cost may be predicated on include a simplified, moderately detailed, or very detailed thermodynamic model of the HVAC system 100. The thermodynamic model of the HVAC system 100 may utilize any of the rated tonnage of the HVAC system 100, the rated Seasonal Energy Efficiency Rating (S.E.E.R.) of the HVAC system 100, Heating and Seasonal Performance Factor (HSPF) of the HVAC system 100, rated furnace efficiency, rated furnace capacity, indoor fan capacity, indoor temperature settings, duct work design, and/or any other suitable HVAC system 100 characteristics.

In some embodiments, generating the first consumption forecast may comprise utilizing a rated capacity of the HVAC system 100 and an assumption that the HVAC system 100 is correctly capacitively matched to the structure 200. Further, because systematic errors present in the first consumption forecast may also appear in a second consumption forecast, the systematic errors may cancel each other out when comparing a first consumption forecast to a second consumption forecast. Similarly, systemic errors may cancel each other out when comparing a first projected cost to a second projected cost.

An estimate of the first projected cost may be based on data related to other structures substantially similar to structure 200. HVAC equipment substantially similar to HVAC system 100 may be monitored and data may be collected that links energy consumption to weather conditions. The system controller 106 may select a closest match of data from monitoring other structures for use in generating at least one of the first consumption forecast and the first projected cost.

In some embodiments, the HVAC system 100 and/or components thereof may be analyzed for their energy consumption by performing HVAC system 100 analysis calculations and/or by performing HVAC system 100 analysis modeling. In some embodiments, the HVAC system 100 analysis calculations and/or HVAC system 100 analysis modeling may comprise use of equations related to the first, second, and/or third laws of thermodynamics, heat balance equations, and/or any other equations related to modeling HVAC, refrigeration, and/or heating systems. In some embodiments, the energy consumption and/or energy costs may be calculated by HVAC system level analysis rather than simply assigning an energy consumption rate to components and tracking run-time of those same components. However, in some embodiments, simply assigning an energy consumption rate to components and tracking run-time of those same components may be used in addition to and/or instead of HVAC system level analysis.

In some embodiments, modeling of the HVAC system 100 may be performed according to widely accepted technical references that provide industry standard calculations regarding the particular HVAC system 100 components. For example, if an HVAC system uses a single-speed electric DX air cooling coil, the thermal performance of the DX cooling coil may be modeled with reference to the equations set out on pages 565-592 of the EnergyPlus Engineering Reference, published by the Board of Trustees of the University of Illinois and the Regents of the University of California through the Ernest Orlando Lawrence Berkeley National Laboratory (2011), which is hereby incorporated by reference in its entirety.

At block 350 in FIG. 3, after controller 106 has generated the first projected cost based on current settings and conditions, the controller 106 may present the first projected cost. A user may and/or computer program may consider whether the first projected cost is acceptable. The presentation of the first projected cost may be accompanied by presentation of the weather forecast data, the current HVAC system 100 settings, the energy cost data (e.g., the current cost of a kilowatt hour), and/or any other appropriate data which may be relevant to the generation of the first projected cost. The presentation of the first projected cost may be accomplished using a touch screen display of system controller 106, other devices 130 such as a smart phone, and/or by a computer logged into CDP 131.

At block 360, the system controller 106 may be provided with a proposed setting for the HVAC system 100. The proposed setting may comprise a heating temperature set point, cooling temperature set point, indoor relative humidity setpoint, fresh air exchange rate, temperature range, and/or any other suitable HVAC system 100 setting. The proposed setting may be provided for an indefinite time period, or may be related to particular time slots. For example, a cooling mode temperature setpoint currently set at 72 degrees F. may be replaced by a proposed setting of 82 degrees F. between the hours of 9:00 am and 4:30 pm. After providing the system controller 106 with the proposed setting, the method 300 may progress to block 370.

At block 370, in response to the system controller 106 receiving the proposed setting, the system controller 106 may produce a second projected cost of operation of the HVAC system 100. The second projected cost may be predicated on the same calculation methods and/or thermodynamic models as the first projected cost is predicated on. In some embodiments, the second projected cost may be generated using different calculations methods and/or thermodynamic models from those used to generate the first projected cost. For example, in generating the first projected cost, matching historical weather data and HVAC system 100 settings may have been utilized, whereas in generating the second projected cost, only matching weather data may be utilized. In the latter case, the projected cost may be modeled or interpolated, whereas in the former case, the projected cost may be based on historical data.

At block 380, system controller 106 may compare the first projected cost to the second projected cost and may determine a cost difference between the two. System controller 106 may also determine which of the first projected cost and the second projected cost is less expensive.

At 390, system controller 106 may present the first projected cost, the second projected cost, and/or a comparison of the two. The presentation may be made by the system controller 106, other devices 130, and/or a computer capable of displaying CDP 131. The system controller 106 may prompt a choice between the original HVAC system 100 setting utilized in generating the first projected cost and the proposed settings utilized in generating the second projected cost.

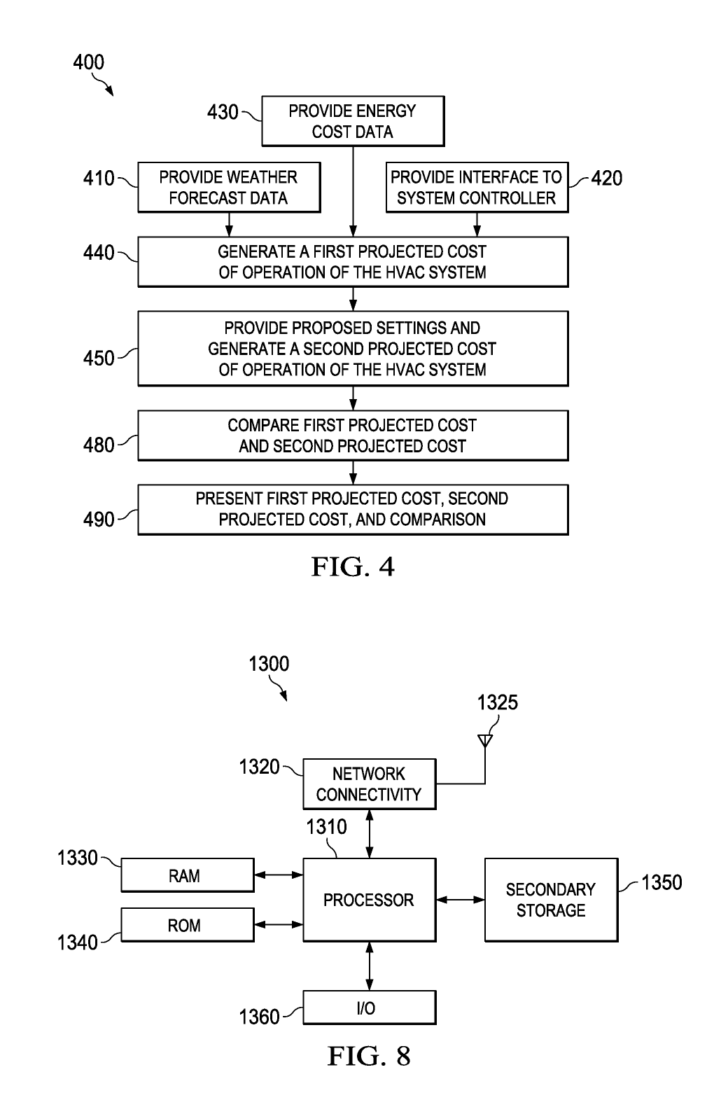

Referring now to FIG. 4, a flowchart of another method 400 of predicting a future energy consumption cost of an HVAC system 100 is shown according to an alternative embodiment of the disclosure. Method 400 is substantially similar to method 300, but method 400 more clearly allows the method to be implemented utilizing systems remote from HVAC system 100. For example, other devices 130 such as a mobile phone or laptop computer may execute a computer program allowing access to system controller settings 106. At block 410, weather forecast data may be provided to a mobile phone or to a laptop. At block 430, energy cost data may be provided to the mobile phone or laptop so that the generation of the first consumption forecast, second consumption forecast, first projected cost, and/or second projected cost may be performed by the mobile phone and/or laptop. Blocks 420, 480, and 490 may be substantially similar to blocks 320, 380, and 390.

Further unlike method 300, at block 450, proposed settings may be generated automatically by the system controller 106, other devices 130, and/or computer connected to CDP 131. The proposed settings may be generated in several ways. In some embodiments, a standard offset from current settings may be generated. For example, a standard offset of three degrees might be generated. In some embodiments, the proposed settings may comprise an indoor climate control program configured to manage temperatures, relative humidity, ventilation, and/or other indoor conditions in response to weather forecast data. In some embodiments, the indoor climate control program may account for the use of structure 200 by the inhabitants. For example, the indoor climate control program may display settings which may only be changed on weekdays during typical working hours. In some embodiments, the indoor climate control program may accept inputs specifying what time periods may not be important for climate control. Inputs for time periods may be recurring (e.g., daily or weekly) patterns or may be assigned only for particular dates.

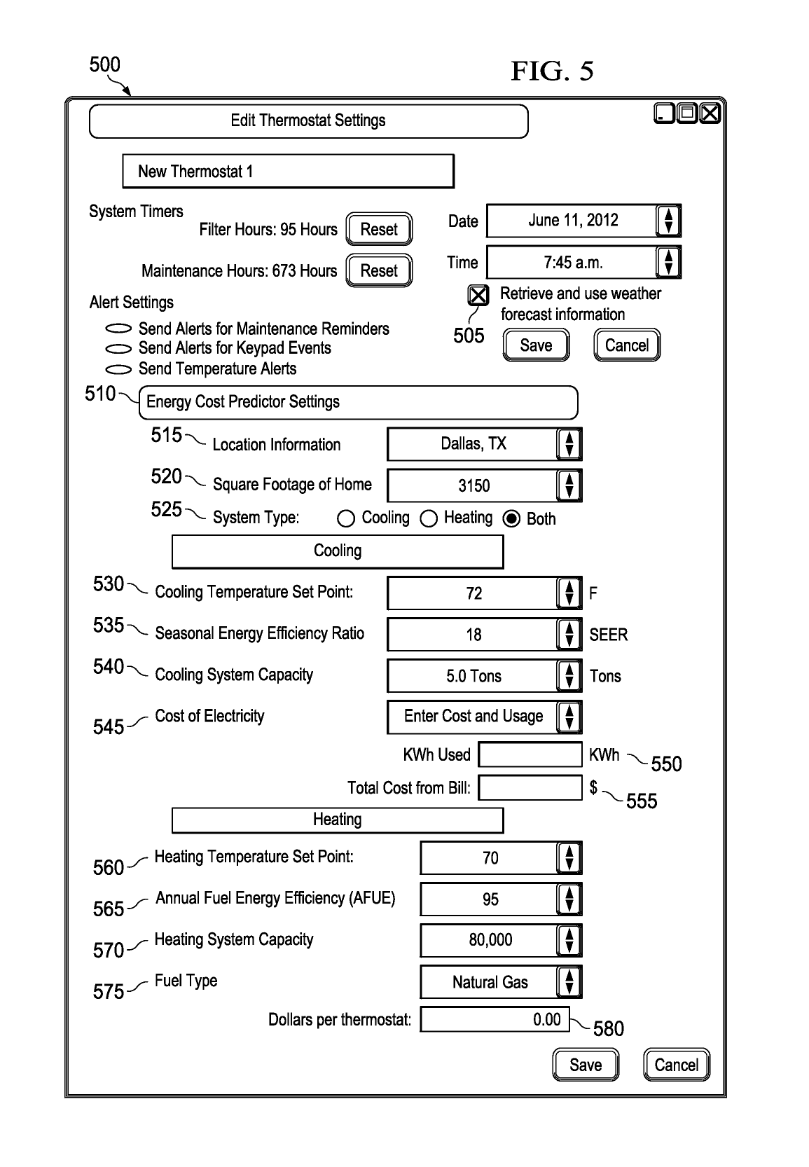

FIG. 5 illustrates an embodiment where the HVAC system 100 may have an interface 500 for entering HVAC system 100 setup settings utilized in generating the first projected cost. The interface 500 may be provided on controller 106, other devices 130, and/or computer connected to CDP 131. In some embodiments, interface 500 may comprise a forecast retrieval check block 505 to instruct HVAC system 100 on whether to retrieve and use weather forecast data. In some embodiments, energy cost predictor settings 510 may be specified. For example, in some embodiments, HVAC system 100 setup settings may comprise location information 515, square footage of home 520, and system type 525.

In some embodiments, cooling settings may comprise cooling temperature set point 530, seasonal energy efficiency ratio 535, cooling system capacity 540, and cost of electricity 545. Interface 500 may also comprise entry locations for total KWh used 550 and total cost from bill 555. Entry locations 550 and 555 may help in determining a cost per KWh. In some embodiments, interface 500 may comprise heating temperature set point 560, annual fuel energy efficiency 565, heating system capacity 570, and fuel type 575. A dollars per therm 580 may also be entered into interface 500. With the HVAC system setup settings entered, the settings may be saved or their entry may be cancelled.

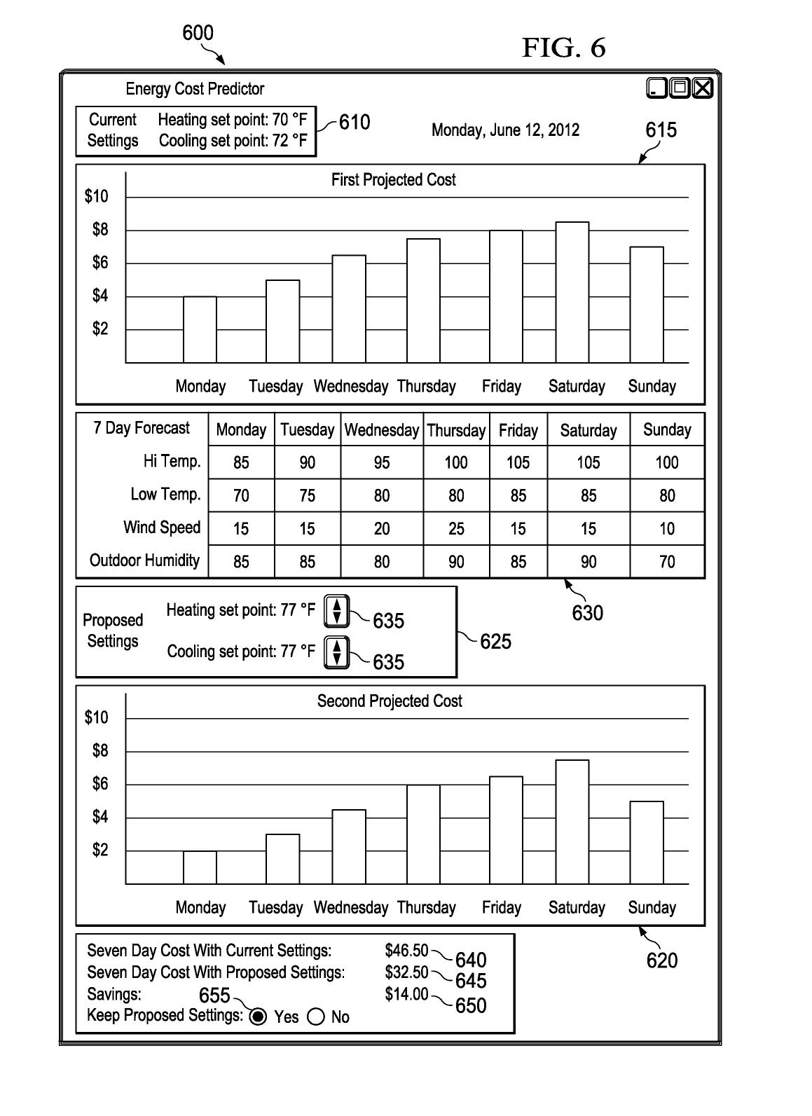

Referring now to FIG. 6, an embodiment of a projected cost comparison interface 600 according to an embodiment of the disclosure is shown. The interface 600 may present HVAC system 100 current settings 610 which may comprise a heating set point and a cooling set point. The interface 600 may also present a first projected cost 615 and a second projected cost 620. A presented seven day forecast 630 may comprise a high temperature, low temperature, wind speed, and outdoor relative humidity level.

Proposed settings 630 may be presented with appropriate adjustors 635 for the proposed settings 630. Second projected cost 620 may be presented. In some embodiments, first cost predictions 640 based on the current settings 610, second cost predictions 645 based on proposed settings 625, a difference 650 between the costs may be presented. Interface 600 may allow a choice of whether to keep and/or implement the proposed settings at 655.

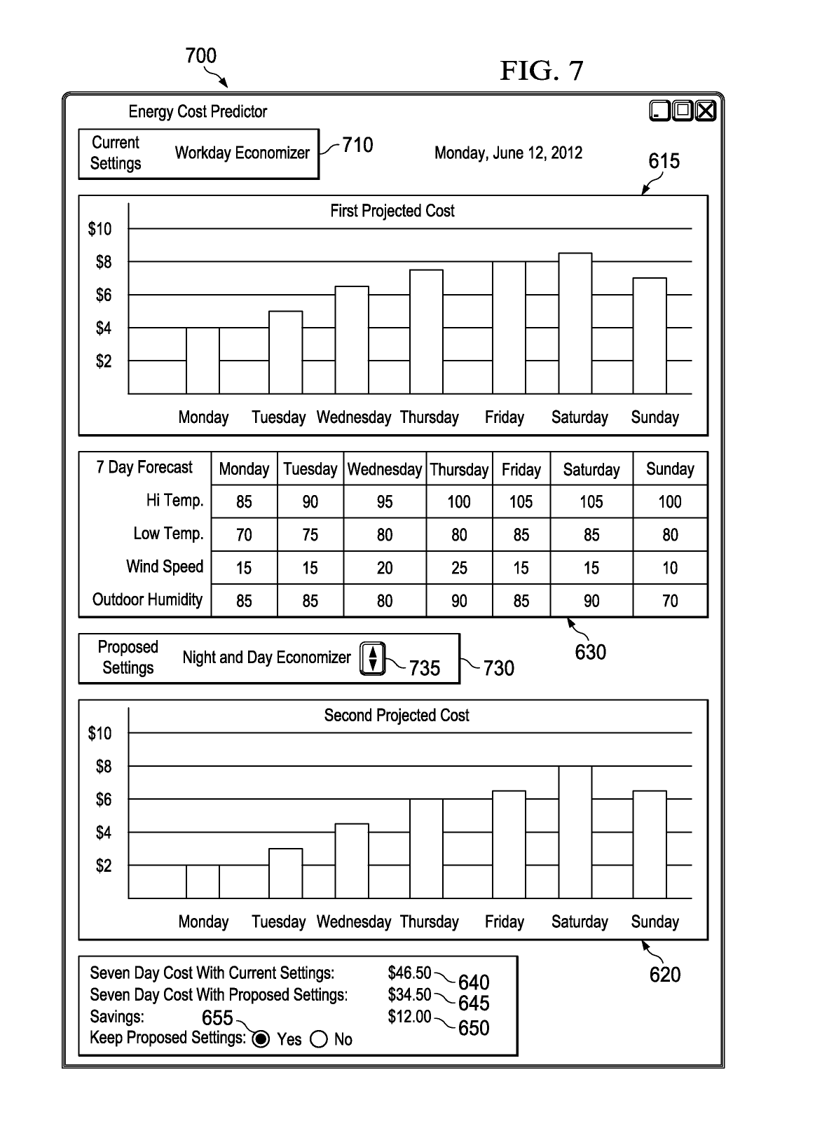

Referring now to FIG. 7, another embodiment of a projected cost comparison interface 700 according to an embodiment of the disclosure is shown. Current settings 710 and proposed settings 735 may comprise scheduled setting modes rather than only temperature setpoints. Any number of HVAC system 100 settings may be changed according to the schedule setting modes, including heating temperature setpoint, cooling temperature setpoint, ventilation settings, relative humidity setpoint, air circulation control, and/or other HVAC system 100 settings amenable to scheduled management. For example, interface 700 may present comparisons of the costs of operating the HVAC system 100 according to each scheduled setting mode over the next seven days and in view of a seven day forecast 630 that comprises weather forecast data. The scheduled setting modes may be factory tested and/or modeled to increase achievement of cost savings.

FIG. 8 illustrates a typical, general-purpose processor (e.g., electronic controller or computer) system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, optical disk, or other drive). While only one processor 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver 1325 may include data that has been processed by the processor 1310 or instructions that are to be executed by processor 1310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs or instructions that are loaded into RAM 1330 when such programs are selected for execution or information is needed.

The I/O devices 1360 may include liquid crystal displays (LCDs), touch screen displays, keyboards, keypads, switches, dials, mice, track balls, voice recognizers, card readers, paper tape readers, printers, video monitors, transducers, sensors, or other well-known input or output devices. Also, the transceiver 1325 might be considered to be a component of the I/O devices 1360 instead of or in addition to being a component of the network connectivity devices 1320. Some or all of the I/O devices 1360 may be substantially similar to various components disclosed herein.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru-Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A method of projecting a cost of operating a heating, ventilation, and/or air conditioning (HVAC) system, comprising:
providing weather forecast data to a system controller of the HVAC system;
providing energy cost data to the system controller;
providing an interface to the system controller; and
generating a first projected cost of operating the HVAC system as a function of the weather forecast data and the energy cost data.

2. The method of claim 1, further comprising:
providing a proposed setting to the system controller.

3. The method of claim 2, further comprising:
generating a second projected cost of operating the HVAC system as a function of the weather forecast data, the energy cost data, and the proposed setting.

4. The method of claim 3, further comprising:
comparing the first projected cost to the second projected cost.

5. The method of claim 4, further comprising:
selecting whether to initiate operation of the HVAC system according to the proposed setting in response to the comparing of the first projected cost to the second projected cost.

6. The method of claim 1, wherein the generating the first projected cost comprises utilizing a thermodynamic model of the HVAC system.

7. The method of claim 1, wherein the first projected cost is determined as a function of a controller setting at which the HVAC system is using to control the HVAC system.

8. The method of claim 7, wherein the controller setting comprises a temperature setpoint.

9. The method of claim 7, wherein the controller setting comprises a schedule.

10. The method of claim 9, wherein the controller setting comprises a temperature setpoint.

11. A heating, ventilation, and/or air conditioning (HVAC) system, comprising:
a system controller configured to receive weather forecast data and energy cost data and further configured to generate a projected cost of operating the HVAC system as a function of the weather forecast data and the energy cost data.

12. The HVAC system of claim 11, wherein the system controller is configured to generate a first projected cost of operating the HVAC system as a function of a controller setting at which the HVAC system is using to control the HVAC system.

13. The HVAC system of claim 12, wherein the system controller is configured to generate a second projected cost of operating the HVAC system as a function of a proposed controller setting.

14. The HVAC system of claim 13, wherein the system controller is configured to suggest the use of the second projected cost of operating the HVAC system when the second projected cost of operating the HVAC system is less than the first projected cost of operating the HVAC system.

15. The HVAC system of claim 14, wherein at least one of the controller setting and the proposed controller setting comprises a temperature setpoint.

16. The HVAC system of claim 15, wherein at least one of the controller setting and the proposed controller setting comprises a schedule.

17. A system controller for a heating, ventilation, and/or air conditioning (HVAC) system, wherein the system controller is configured to receive weather forecast data and energy cost data and further configured to generate a projected cost of operating the HVAC system as a function of the weather forecast data and the energy cost data.

18. The HVAC system of claim 17, wherein the system controller is configured to generate a first projected cost of operating the HVAC system as a function of a controller setting at which the HVAC system is using to control the HVAC system.

19. The HVAC system of claim 18, wherein the system controller is configured to generate a second projected cost of operating the HVAC system as a function of a proposed controller setting.

20. The HVAC system of claim 19, wherein the system controller is configured to suggest the use of the second projected cost of operating the HVAC system when the second projected cost of operating the HVAC system is less than the first projected cost of operating the HVAC system.
